(19) United States
(12) Patent Application Publication
(10) Pub. No.: US 2026/0129215 A1
(43) Pub. Date: May 7, 2026

(54) FEATURE PICTURE HEADER FOR FEATURE COMPRESSION BITSTREAMS

(71) Applicant: InterDigital VC Holdings, Inc., Wilmington, DE (US)

(72) Inventors: Fabien Racape, San Francisco, CA (US); Hyomin Choi, Sunnyvale, CA (US); Ahmed Hamza, Coquitlam (CA); Gurdeep Bhullar, Montreal (CA)

(73) Assignee: InterDigital VC Holdings, Inc., Wilmington, DE (US)

(21) Appl. No.: 18/989,478

(22) Filed: Dec. 20, 2024

Related U.S. Application Data
(60) Provisional application No. 63/715,339, filed on Nov. 1, 2024.

(51) Int. Cl. H04N 19/169; H04N 19/132; H04N 19/136; H04N 19/31

(52) U.S. Cl. CPC H04N 19/188; H04N 19/132; H04N 19/136; H04N 19/31

(57) ABSTRACT

Systems, methods, and instrumentalities for a feature picture header (FPH) for feature compression bitstreams. An example video decoding device may receive a first FPH network abstraction layer (NAL) unit that indicates a first feature picture parameter set (FPPS) associated with a first frame. The device may decode the first frame. The device may reconstruct a first set of features associated with the first frame based on the first FPPS. The device may receive a second FPH NAL unit that indicates a second FPPS associated with a second frame. The device may decode the second frame. The device may reconstruct a second set of features associated with the second frame based on the second FPPS.

### CROSS-REFERENCE TO RELATED APPLICATIONS

This application claims the benefit of U.S. Provisional Application No. 63/715,339, filed Nov. 1, 2024, the contents of which is incorporated by reference herein.

### BACKGROUND

The present application is related to video coding systems that may be used to compress digital video signals, e.g., to reduce the storage and/or transmission bandwidth needed for such signals. Video coding systems may include, for example, block-based, wavelet-based, and/or object-based systems.

### BRIEF SUMMARY

Systems, methods, and instrumentalities are disclosed herein for a feature picture header for feature compression bitstreams.

An example device for video decoding may receive a first feature picture header (FPH) network abstraction layer (NAL) unit that indicates a first feature picture parameter set (FPPS) associated with a first frame. The device may decode the first frame. The device may reconstruct a first set of features associated with the first frame based on the first FPPS. The device may receive a second FPH NAL unit that indicates a second FPPS associated with a second frame. The device may decode the second frame. The device may reconstruct a second set of features associated with the second frame based on the second FPPS.

The first FPH further may indicate whether temporal up-sampling is enabled. On a condition that temporal up-sampling is enabled, the device may automatically generate a third frame that is temporarily prior to the first frame. The device may output the decoded first frame, the decoded second frame, the reconstructed first set of features, and the reconstructed second set of features.

The first FPH NAL unit may include an indication of a first picture order count associated with the first frame. The second FPH NAL unit may include an indication of a second picture order count associated with the second frame. The device may identify the first frame based on the first picture order count. The device may identify the second frame based on the second picture order count.

An example device for video encoding may determine a first FPPS associated with a first frame. The device may encode a first FPH NAL unit that comprises an indication of the first frame and the determined first FPPS. The device may determine a second FPPS associated with a second frame. The device may encode a second FPH NAL unit that comprises an indication of the second frame and the determined second FPPS.

The FPH NAL may include an indication of whether temporal up-sampling is enabled. The first FPPS may include a first parameter for reconstructing intermediate data associated with the first frame. The second FPPS may include a second parameter for reconstructing intermediate data associated with the second frame.

The first FPH NAL unit may include an indication of a first picture order count associated with the first frame. The second FPH NAL unit may include an indication of a second picture order count associated with the second frame.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1 shows an example system according to one or more embodiments of the present disclosure.

FIG. 2 shows an example video encoder according to one or more embodiments of the present disclosure.

FIG. 3 shows an example video decoder according to one or more embodiments of the present disclosure.

FIG. 4 shows an example of split computing in which the inference of a neural network (NN) may be shared between multiple devices (e.g., two remote devices).

FIG. 5 illustrates an example of decomposing feature compression and/or decompression.

FIG. 6 illustrates an example of a feature coding for machine (FCM) decoder.

FIG. 7 illustrates an example bitstream structure for FCM using a video bitstream augmented with supplemental enhancement information (SEI) messages.

FIG. 8 illustrates an example bitstream organization for FCM that includes sets of network abstraction layer (NAL) units.

FIG. 9 illustrates an example FCM bitstream structure.

FIG. 10 illustrates an example FCM bitstream structure.

FIG. 11 illustrates an example structure augmented with SEI coding for vision model (VM) related information.

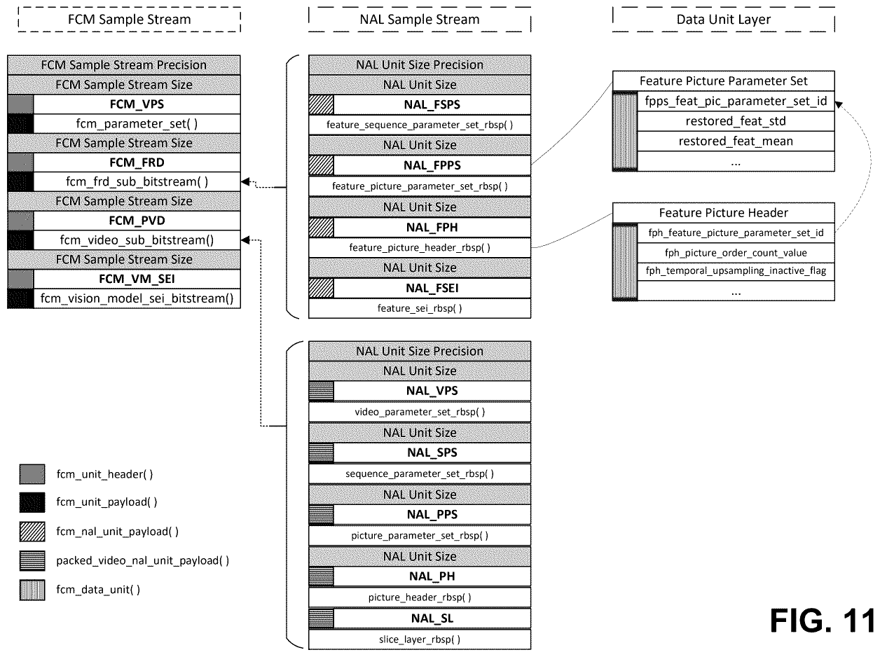

FIG. 12 illustrates an example structure for video coding for machine (VCM).

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

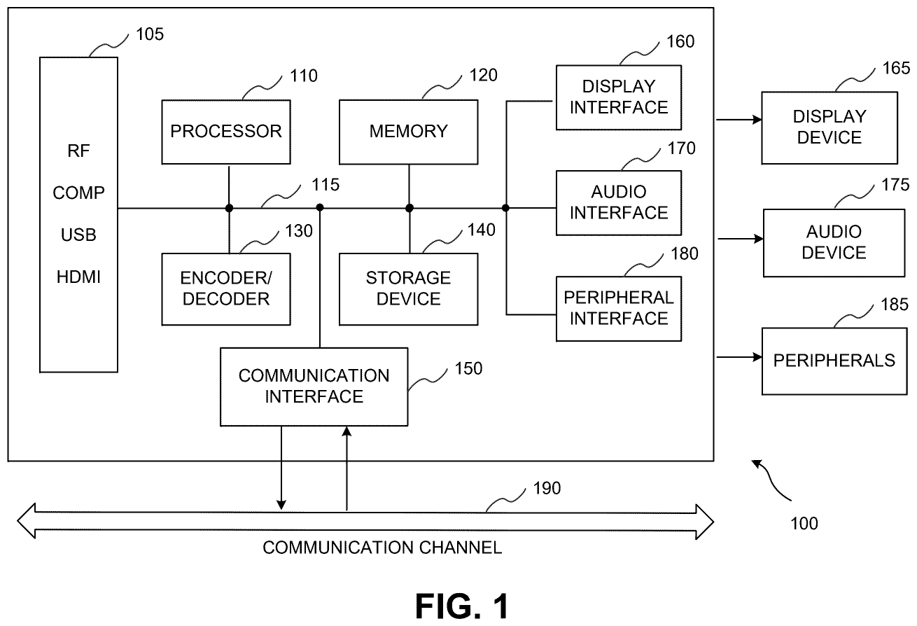

Referring to the drawings, there is shown in FIG. 1 a block diagram illustrating an example system 100 in which embodiments of the present disclosure can be implemented. The system 100 may be an electronic device including, for example, a personal computer, laptop computer, mobile phone, tablet computer, multimedia set-top box, digital television receiver, personal video recording system, connected home appliance, vehicle control and/or entertainment system, and server. One or more elements of the system 100, singly or in combination, may be implemented as an integrated circuit (IC), multiple ICs, and/or discrete components. For example, in one embodiment, the processing, encoding and/or decoding elements of system 100 are distributed across multiple ICs and/or discrete components. In some embodiments, the system 100 is communicatively coupled to and/or in communication with other systems or devices, via, for example, a communications bus or dedicated input/output ports.

One or more of the elements of system 100 may be provided within an integrated housing, with such elements being interconnected and able to transmit data therebetween using any suitable connection arrangement 115 generally known in the art, including, for example, an internal bus (e.g., 12C bus), wiring, and printed circuit boards.

The system 100 may include at least one processor 110 configured to execute instructions for implementing the embodiments described herein, including signal/data coding and processing. The processor 110 may be a general-purpose processor or microprocessor, digital signal processor (DSP), one or more microprocessors in association with a DSP core, a controller, a microcontroller, application specific integrated circuits (ASICs), field programmable gate arrays (FPGAs), a state machine, and the like. The processor 110 may include at least one central processing unit (CPU), embedded memory, input and output interfaces, and other circuitries.

The system 100 may include at least one memory 120, for example, a volatile memory device and/or a non-volatile memory device. The system 100 may include a storage device 140, that may be or include non-volatile memory and/or dynamic volatile memory, including EEPROM, ROM, PROM, RAM, DRAM, SRAM, DDR, flash, magnetic disk drives, solid state drives (SSD) and/or optical disk drives. The storage device 140 may be or include, for example, an internal storage device, an attached storage device, and/or a network accessible storage device. Although shown separately, the memory 120 and the storage device 140 may be collocated, integrated together, or otherwise combined.

The system 100 may include an encoder/decoder module 130 configured to process video data and to provide encoded video data or decoded video data. The encoder/decoder module 130 may include one or more processors and/or memory (not shown). Although FIG. 1 depicts the encoder/decoder module 130 as a separate element of system 100, it will be understood that the processor 110 and the encoder/decoder module 130 may be collocated and/or integrated together as a combination of hardware and/or software, e.g., in an electronic package or chip. The encoder/decoder module 130 may be or include one or more modules that may be included in one or more separate devices that perform encoding and/or decoding functions.

Instructions for execution by the processor 110 and/or the encoder/decoder module 130 may be stored in the storage device 140 and subsequently loaded into memory 120 for execution by the processor 110. In some embodiments, one or more of processor 110, memory 120, storage device 140, and encoder/decoder module 130 may store one or more items when performing the processes disclosed herein. Such items may include input video, decoded video or portions thereof, bitstreams, matrices, variables, operational logic, and intermediate and/or final results from processing of equations, formulas, or operations.

In some embodiments, the memory of the processor 110 and/or the encoder/decoder module 130 may be used to store instructions and/or provide working memory for video encoding and decoding functions. In some embodiments, memory external to the processor 110 and/or the encoder/decoder module 130 (e.g., the memory 120 and/or the storage device 140) may be used for one or more of these functions and/or, for example, to store the operating system of a television.

The system 100 may obtain or receive information via one or more input devices, interfaces, and/or ports as indicated in input block 105. Examples of the input devices include a radio frequency (RF) device for transmitting and/or receiving RF signals over various media, for example, RF signals received over the air from a broadcaster; component video (COMP) inputs; a Universal Serial Bus (USB) input; and/or a High-Definition Multimedia Interface (HDMI) input. Other examples include composite video input (not shown). In some embodiments, the input devices are associated with respective input processing elements, e.g., those generally known in the art. For example, the RF device may be associated with elements suitable for selecting a desired frequency (e.g., selecting or band-limiting a signal) or performing error correction on the signal. The USB and/or HDMI inputs may include respective interface processors and transceivers (or transmitters and receivers) for coupling the system 100 to other devices via USB and/or HDMI ports or connections. Various forms of input processing may be implemented, for example, by and/or within a separate input processing device or the processor 110.

The system 100 may include a communication interface 150 that enables wired and/or wireless communication with other devices, e.g., via a communication channel 190. The communication interface 150 may include one or more transceivers, modems, network cards and the like. The communication channel 190 may be or include wired and/or wireless mediums.

In some embodiments, data may be streamed to the system 100 via wired and/or wireless networks. Examples of such wireless networks include cellular, Bluetooth or Wi-Fi (e.g., IEEE 802.11) networks. The wired and/or wireless networks may include one or more base stations (e.g., cellular base stations, access points, etc.), and/or user equipment (e.g. cellular user equipment, stations, etc.), and/or other network elements that communicate with the system 100 via the communication interface 150 and communication channel 190, whereby the system 100 may obtain data streamed from streaming applications (e.g., over-the-top (OTT) services) via various networks, including the Internet. In some embodiments, data is streamed to the system 100 via the input block 105 (e.g., using a set-top box that delivers data via the HDMI connection or the RF connection). In some embodiments, data is received by the system 100 in a non-streaming manner.

The system 100 may provide one or more output signals to one or more output devices. The output devices may include a display device 165 (e.g., touchscreen display, monitor, etc.), an audio device 175 (e.g., speakers), and other peripheral devices 185, including, for example, a stand-alone DVR, a disk player, a stereo system, a lighting system, and other devices that provide a function based on the output of the system 100. The display device 165 can be for a television, tablet, laptop, mobile phone, head-mounted display, or other device. In some embodiments, control signals are communicated between the system 100 and the display device 165, the audio device 175, and/or the peripheral devices 185, enabling device-to-device control with or without user intervention. The output devices may couple to and/or communicate with the system 100 via dedicated connections via respective display, audio, and peripheral interfaces 160, 170, 180. Alternatively, the output devices may couple to and/or communicate with the system 100 via the communication channel 190 and the communication interface 150.

The display device 165 and the audio device 175 may be collocated, integrated, or otherwise combined with the other components of system 100 in a single unit (e.g., a television). Alternatively, the display device 165 and the audio device 175 may be separate from one or more of the other components of the system 100. In embodiments in which the display device 165 and the audio device 175 are external components, the output signals may be provided via dedicated outputs and/or connections, including, for example, HDMI ports, USB ports, or COMP outputs.

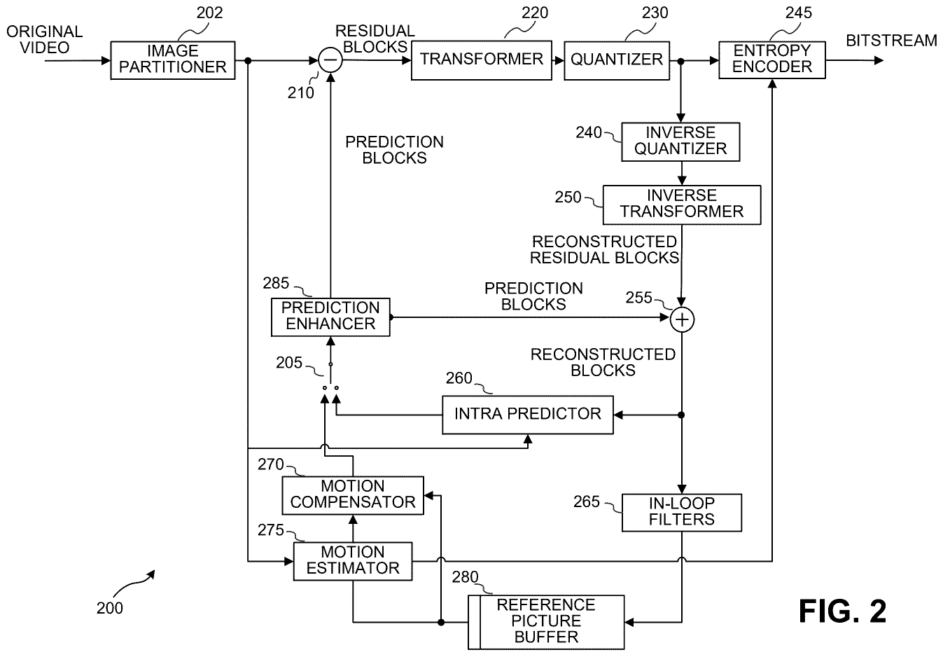

FIG. 2 is a block diagram illustrating an example video encoder 200 that may be employed by the system 100 (e.g., via the encoder/decoder module 130) described with respect to FIG. 1. The video encoder 200 may be an encoder that employs video compression technologies, standards, specification, or protocols, including Advanced Video Coding (AVC, H.264/MPEG-4), High Efficiency Video Coding (HEVC, H.265), Versatile Video Coding (VVC, H.266), Essential Video Coding (EVC, MPEG-5), AOMedia Video 1 (AV1), VP9, or the Enhanced Compression Model (ECM), and variations or improvements thereof. Those skilled in the art will understand that the various embodiments described herein are not limited to a specific standard and can be applied to other standards and recommendations, as well as extensions thereof.

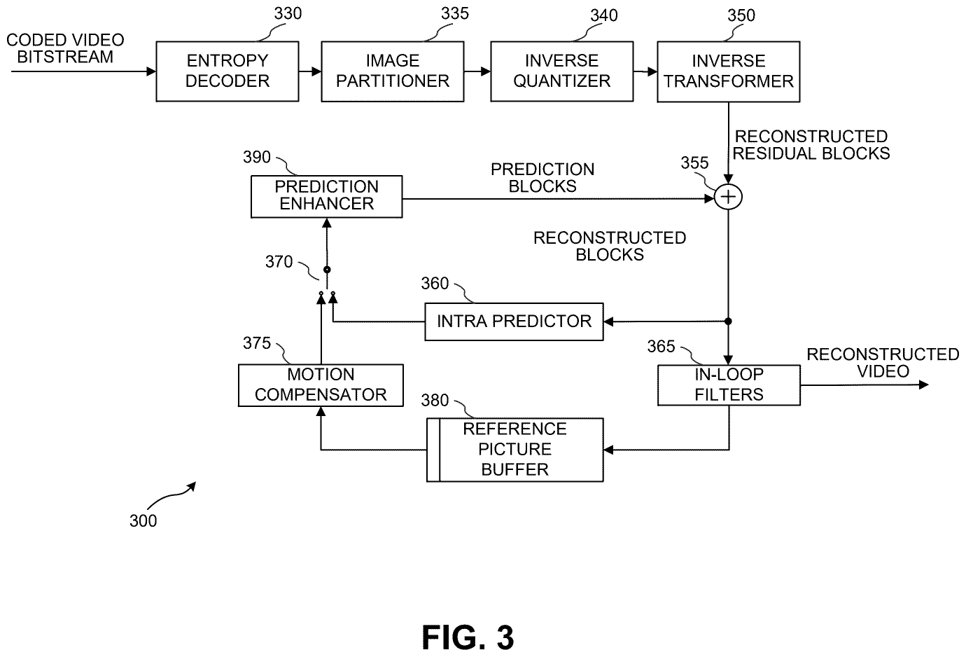

Some embodiments disclosed herein are described with reference to a coding unit (CU) or block of a video frame (or a video image or picture) to which coding tools may be applied by the video encoder 200 and/or by the video decoder 300 (described below with reference to FIG. 3). Generally, embodiments described herein may be applied to a video region formed by a video partition of any shape or size. The video region may be a video slice, a coding tree unit (CTU), or a CU (to which inter prediction or intra prediction can be applied), or a partition thereof, each of which can include samples of a luma component, Y, and chroma components, U and V (also denoted herein by C, Cb, Cr).

Referring generally to FIG. 2 and the video encoder 200, video data (e.g., one or more video frames) is encoded generally as described below. Prior to encoding, video data may be pre-processed by a precoding processor (not shown). The pre-processing may include, for example, applying a color model transform to the input color components of the input video data (e.g., conversion from RGB 4:4:4 to YUV 4:2:0) or mapping the color components of the input video data to obtain a signal distribution that is more resilient to compression (for instance, applying a histogram equalizer and/or a denoising filter to one or more of the video data's color components). The pre-processing may include associating metadata (for example, a supplemental enhancement information (SEI) message) with the video data that can be attached to a coded video bitstream. After pre-processing, if any, an image (frame) to be encoded is partitioned into CUs (blocks) by an image partitioner 202.

In general, a CU may include a luma block and associated chroma blocks. As such, functions of the video encoder 200 described herein as applied to a CU refer generally to the luma block and the respective chroma blocks. The CUs may be encoded using an intra prediction mode performed by an intra predictor 260. In intra prediction mode, the content of a CU in a frame is predicted based on content from one or more other CUs of the same frame (or region), using reconstructed blocks of other CUs output from an adder 255. The CUs may also or alternatively be encoded using an inter prediction mode, in which motion estimation and motion compensation are performed by a motion estimator 275 and a motion compensator 270, respectively. In inter prediction mode, the content of a CU in a frame is predicted based on content from one or more reconstructed areas of reference frames, available from a reference picture buffer 280.

The video encoder 200 selects or otherwise determines at 205 which prediction mode (intra prediction mode and/or inter prediction mode) to use for encoding a CU. The selected prediction mode may be enhanced (e.g., filtered) by a prediction enhancer 285. Based on the selected mode, a prediction for the CU is generated. A residual block is determined based on the prediction (e.g., prediction block, predicted CU) and the input CU. In some embodiments, such determination is made by a subtractor 210.

The residual block or a partition thereof (e.g., a transform block) is transformed into transform coefficients by a transformer 220. The transform coefficients are quantized by a quantizer 230. An entropy encoder 245 performs entropy encoding of the quantized transform coefficients and coding parameters (e.g., syntax elements including motion vectors and other control data) to form a bitstream of coded video data.

In addition to coding the original video blocks as described herein, the video encoder 200 reconstructs the coded blocks to provide references for future predictions. Thus, quantized transform coefficients (from the quantizer 230) are de-quantized by an inverse quantizer 240, and inverse transformed by an inverse transformer 250, to reconstruct (decode) the residual blocks. The reconstructed residual blocks and prediction blocks are combined (e.g., by the adder 255) to form reconstructed blocks. Thus, the video encoder 200 performs decoding operations through which the encoded images (frames) are reconstructed.

In-loop filters 265 may be applied to the reconstructed image (formed by the reconstructed blocks). The filtered reconstructed image(s) are stored in the reference picture buffer 280 and used by the motion estimator 275 and motion compensator 270, as explained above. The in-loop filters 265 can be applied to the reconstructed samples of an image to reduce distortions introduced by the encoding process. For example, a deblocking filter (DBF), bilateral filter (BIF), sample adaptive offset (SAO), and/or adaptive loop filter (ALF) can be applied to reduce encoding artifacts.

FIG. 3 is a block diagram illustrating an example of video decoder 300 that may be employed by the system 100 (e.g., via the encoder/decoder module 130) described with respect to FIG. 1. Generally, operational features of the video decoder 300 are reciprocal to operational features of the video encoder 200. In the video decoder 300, a coded video bitstream (e.g., generated by the video encoder 200 or another video encoding device or process) is entropy-decoded by an entropy decoder 330 to obtain transform coefficients, motion vectors, and other coding parameters. Based on the coding parameters, an image partitioner 335 divides the picture accordingly. The quantized transform coefficients are de-quantized by an inverse quantizer 340 and inverse transformed by an inverse transformer 350 to decode (e.g., reconstruct) respective residual blocks. Depending on the selected prediction mode, a predicted block can be obtained at 370 from an intra predictor 360 (e.g., intra prediction) or from a motion compensator 375 (e.g., inter prediction) and may be enhanced (e.g., filtered) by a prediction enhancer 390, generating a prediction block. The reconstructed residual blocks are combined with prediction blocks (e.g. by an adder 355), resulting in reconstructed blocks.

In-loop filters 365 (e.g., DBF, BIF, SAO, and/or ALF) can be applied to the reconstructed image (formed by the reconstructed blocks), to output reconstructed (decoded) video. The filtered reconstructed image is also stored in a reference picture buffer 380 for reference by the motion compensator 375.

A post-decoding processor (not shown) can process the reconstructed video data. For example, post-decoding processing can include an inverse color model transform (e.g., conversion from YUV 4:2:0 to RGB 4:4:4) or an inverse mapping to reverse the mapping process performed by the pre-encoding processor described with respect to FIG. 2. The post-decoding processor can use metadata derived by the pre-encoding processor and/or signaled in the video bitstream.

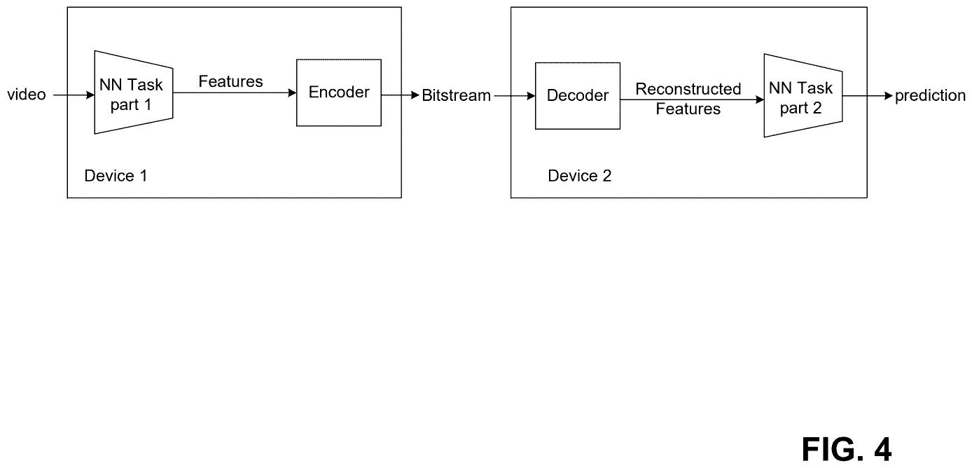

FIG. 4 illustrates an example of split computing (sometimes also referred to as split-inferencing), in which the inference of a neural network (NN) may be shared between multiple devices (e.g., two remote devices). As shown in FIG. 4, an output of a first part (e.g., NN task part 1) of a split NN on device 1 may include features extracted by the NN (e.g., which may be referred to herein as intermediate data at a split point) and/or may be transmitted to a Device 2 (e.g., a remote Device 2). In examples, the transmission may compress (e.g., may need to compress) the intermediate data by means of one or more features associated with video encoding (e.g., using a video encoding device and/or a video encoder). In examples, the transmission by compress the intermediate data by one or more features associated with any type of input (e.g., audio, text, medical imaging, etc.). Device 2 (e.g., including a video decoding device and/or a video decoder) may receive and decode the intermediate data. The decoded intermediate data may be outputted to a second part of the split NN (e.g., NN task part 2). In examples, device 1 may correspond to a battery-operated camera and device 2 may correspond to a remote cloud server. In examples, such splitting of the NN (e.g., a NN-based model) may be used to offload some of the computations if the device (e.g., the battery-operated camera) that captures and/or stores source contents (e.g., videos) is limited in terms of processing power, memory, and/or energy (e.g., battery power).

The examples provided herein may describe one split point (e.g., an NN being divided into two parts), but the techniques described in those examples may also be used to split an NN into more than two parts (e.g., with more than one split one) and/or among multiple (e.g., more than two) devices. In examples, adequate video data, such as bitstreams of intermediate data, may be created for one or more split points (e.g., at each split point).

When used herein, the term “video” may include image and/or video contents. Further, while video may be used as an example input to a neural network (e.g., NN task part 1 as shown in FIG. 4) in the examples provided herein, the neural network technology described herein may be used to process any type of input (e.g., audio, text, medical imaging, etc.).

Different techniques may be used to compress intermediate data (e.g., data at a split point of a neural network). These techniques may include, for example, transforming the intermediate data into an array (e.g., a two-dimensional (2D) array) and applying image and/or video coding/decoding techniques (e.g., signal prediction, transforms, quantization, re-sampling, entropy coding, etc.) to the array of data, for example, to reduce the size of a bitstream.

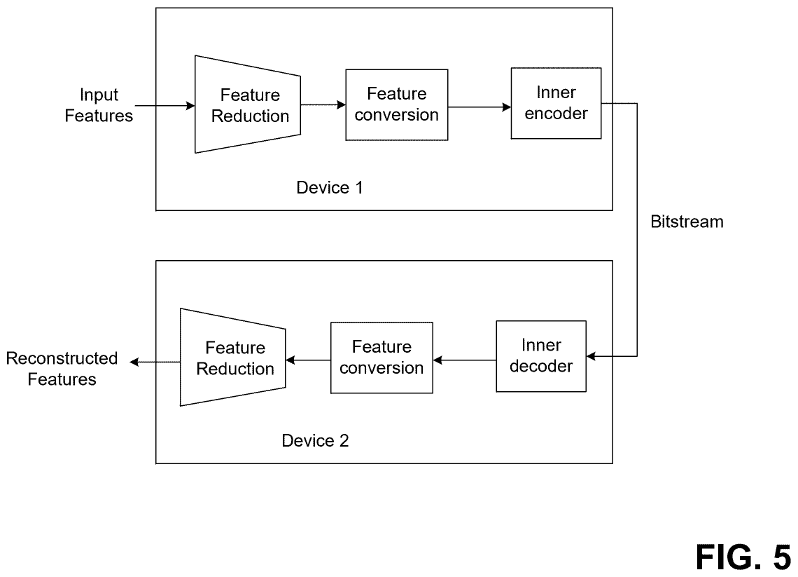

FIG. 5 illustrates an example of decomposing feature compression and/or decompression. As shown in FIG. 5, an encoder (e.g., device 1 in the figure) may perform one or more feature reduction operations that may transform potentially large tensors or lists of tensors into smaller ones, while keeping the relevant information. The encoder may fuse tensors together (e.g., if input features include multiple tensors). For video tasks, the input may be a stream of feature tensors. The stream of feature tensors may include multiple tensors for a (e.g., each) time instance. The feature reduction may create a compact tensor with information (e.g., that keeps most of the relevant information) associated with the performance of the machine vision task. This stage may include trained neural networks.

FIG. 5 illustrates an example of packed feature tensors onto a monochrome video frame. In this example, features may include tensors of 256 channels at different resolutions (e.g., the tensors packed at the bottom have lower resolution channels). The reduced feature tensors may be converted into an image or video that may be fed to an image or video coder/decoder (e.g., codec), denoted as inner encoder and decoder in FIG. 5. In the case where intermediate data corresponds to a tensor of dimension H×W×C, where H, W, C may denote the height, width, and number of channels of the input data, respectively, the channels may be organized as the tiles of a large, packed frame. For instance, if C is a power of two, e.g., such as 64, the packed frame may correspond to a tiling of 8×8, resulting from a frame of size (8*W)×(8*H). The resulting frame may be monochrome (e.g., in a YUV 4:0:0 format for at least some video codecs). The conversion process may include normalizing and/or quantizing the tensor values to be rescaled as unsigned integer values (e.g., in the range of bit-depth supported by the codec, such as, e.g., 8 or 10 bits).

The packed frame may be encoded, which may result in video data, such as a bitstream. The bitstream may include additional metadata that may specify parameters and/or settings for the reconstruction of the intermediate data (e.g., unpacking, rescaling to the original range of values, restoring the tensors to their original size and shape, etc.).

A decoder (e.g., device 2 of FIG. 5) may perform operations inverse to those of the encoder, as illustrated in FIG. 5. For example, the decoder may read a coded bitstream and the metadata included therein, and feed decoded frames to a feature conversion and restoration process. As part of the feature conversion, the decoder may perform inverse scaling and/or de-packing of one or more tensor channels, for example, based on scaling factors and/or geometric arrangement of the tensor channels within the packed frame. As part of the feature restoration, the decoder may take reduced tensors and transform them back to feature tensor or list of tensors of an original size. The feature conversion and/or restoration process may utilize (e.g., benefit from) metadata transmitted within the bitstream to parametrize the process, for example, with respect to an encoder side reduction process that may have been applied for a specific split task model or for specific contents. For instance, the feature restoration process may include learned operations, such as, e.g., learning the layer parameters (e.g., weights) of the neural network that may be specific to the content being coded.

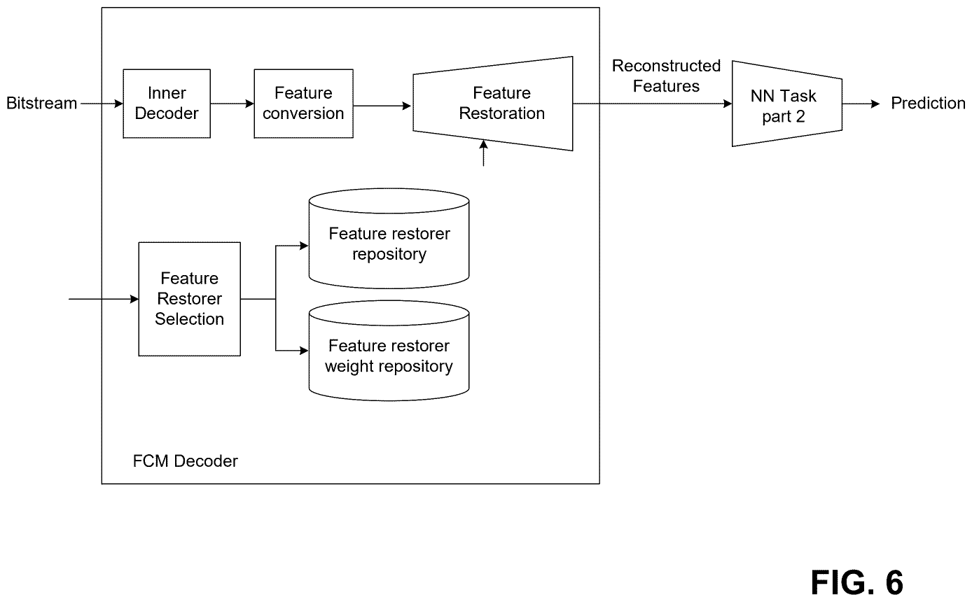

FIG. 6 illustrates an example of a feature coding for machine (FCM) decoder. The structure of an FCM decoder may be built on top of existing codecs, for example, as illustrated in FIG. 6. The bitstream shown in FIG. 6 may be a video data, such as video bitstream (e.g., to be decoded), that may include one or more packed tensors, augmented with syntax indicating necessary elements to select from an available feature restorer architecture, and/or corresponding sets of weights. Multiple sets of weights may be defined for the same architecture (e.g., when multiple task models share a similar architecture). A model may be trained toward different tasks. A feature restoration process may take (e.g., as input) converted features and parametrize the features (e.g., using restorer parameters) to reconstruct one or more decoder output feature tensors. The decoded tensors may be (e.g., after decoding) used as input to derive an inference (e.g., the inference of NN Task part 2 as shown in FIG. 4).

Examples associated with Feature Compression (FCM) may include Neural-Network (NN)-based reduction and feature restoration modules. The NN-based reduction and feature restoration modules may be trained to create compact features that can be mapped onto 2D frames to be fed to an inner codec. The inner codec may correspond to a standalone video or image compression already defining a self-contained bitstream. In some examples, performances of inner codecs may depend on the capacity of the feature reduction approach. However, in other examples, performances of inner codecs may not depend on the capacity of the feature reduction approach as the feature reduction approach may lack some flexibility. The feature reduction approach may lack flexibility in producing feature tensors of the same size (e.g., regardless of what the target operation point (e.g., bitrate/task accuracy) is and regardless of what the input content is). For example, the same model structure may be used regardless of what the target bitrate point is. The output number of channels may be fixed. The fixed pretrained reductor may produce features which may include channels that are not relevant to the end accuracy.

A bitstream structure may convey feature conversion and/or restoration information in units (e.g., dedicated units) to the decoder (e.g., alongside units of a video steam).

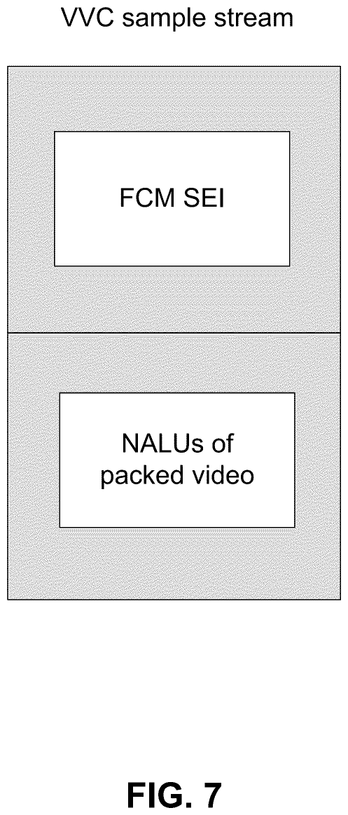

FIG. 7 illustrates an example bitstream organization for FCM using a video bitstream augmented with SEI message(s).

A bitstream structure may have different Network Abstraction Layer (NAL) Units (NALU) types. The NALU types may include different parameters sets and/or payloads of video data. The conversion and/or restoration parameters may be included in a Supplemental Enhancement Information (SEI) message. The bitstream may be a 2D video bitstream with units of packed videos (e.g., augmented with associated SEI messages, as illustrated in FIG. 7). SEI messages may not modify (e.g., may not require modifying) the decoding operations of corresponding codec (e.g., the decoding of the 2D video frames from the 2D codec perspective). Feature restoration operations may be defined using the output frames of the 2D codec and/or the corresponding SEI message(s) (e.g., including feature conversion and/or restoration information).

This technique may lack flexibility if transmitting the restoration parameters for video frames (e.g., the different video frames). For example, if a parameter is updated (e.g., needs to be regularly updated) for a given period of frames, the SEI message (e.g., the whole SEI message) may be transmitted.

FCM may specify parameter set(s) (e.g., similar to parameter set in video codecs, for example, a Feature Sequence Parameter Set (FSPS) with information relevant at the sequence level, and/or a Feature Picture Parameter Set (FPPS) with information that may be updated at frame level). These sets may be organized in the bitstream.

Example FSPS and FPPS are illustrated in Tables 1 and 2, respectively.

TABLE 1
Example FSPS

| | Descriptor |
|---|---|
| feat_seq_parameter_set_rbsp ( ) { | |
| fsps_feat_seq_parameter_set_id | |
| num_ori_feat_layers | |
| for (I = 0; i <= num_feature_layers; i++) { | |
| ori_feat_wid[i] | |
| ori_feat_hei[i] | |
| num_ori_feat_chan[i] | |
| } | |
| fused_feat_wid | |
| fused_feat_hei | |
| inner_decoding_bypass_flag | |
| if( !inner_decoding_bypass_flag ) { | |
| feat_inner_decoder_info( ) | |
| } | |
| dequant_bypass_flag | |
| unpacking_bypass_flag | |
| feat_restoration_bypass_flag | |
| if( !feat_restoration_bypass_flag ) | |
| feat_restoration_info( ) | |
| } | |
| temporal_upsampling_enable_flag | u(1) |
| restored_feat_refine flag | u(1) |
| fused_feat_refine_flag | u(1) |
| if (restored_feat_refine_flag ) { | |
| restored_feat_refine_refresh_period | u(8) |
| } | |
| if(fused_feat_refine_flag) { | |
| fused_feat_refine_refresh_period | u(8) |
| } | |
| rbsp_trailing_bits( ) | |
| } | |

TABLE 2
Example FPPS

| | Descriptor |
|---|---|
| feature_pic_parameter_set_rbsp( ) { | |
| fpps_feat_pic_parameter_set_id | |
| fpps_feat_seq_parameter_set_id | |
| if( !dequant_bypass_flag ) { | |
| ... | |
| } | |
| if( !unpacking_bypass_flag ) { | |
| ... | |
| } | |
| if(restored_feat_refine_flag ) { | |
| if( VVC:PicOrderCntVal % restored_feat_refine_refresh_period == 0 ) { | |
| restored_feat_std | bf(16) |
| restored_feat_mean | bf(16) |
| } | |
| } | |
| if(fused_feat_refine_flag ) { | |
| if( VVC::PicOrderCntVal % fused_feat_refine_refresh_period == 0 ) { | |
| fused_feat_std | f(32) |
| fused_feat_mean | f(32) |
| } | |
| } | |
| rbsp_trailing_bits( ) | |
| } | |

As shown in Table 2, the FPPS may include feature conversion and/or restoration parameter(s) (e.g., restored_feat_std and restored_feat_mean). The restoration parameter(s) may drive the reconstruction of the feature (e.g., with the help of information on the original distributions of the feature values). A condition on the picture order count (POC, for example, denoted PicOrderCntVal) may be set to parse those parameters. The POC may be derived from the decoded data. The POC may be fetched from the video sub-bitstream. The parsed FPPS may be synchronized with a corresponding decoded picture from the video-bitstream.

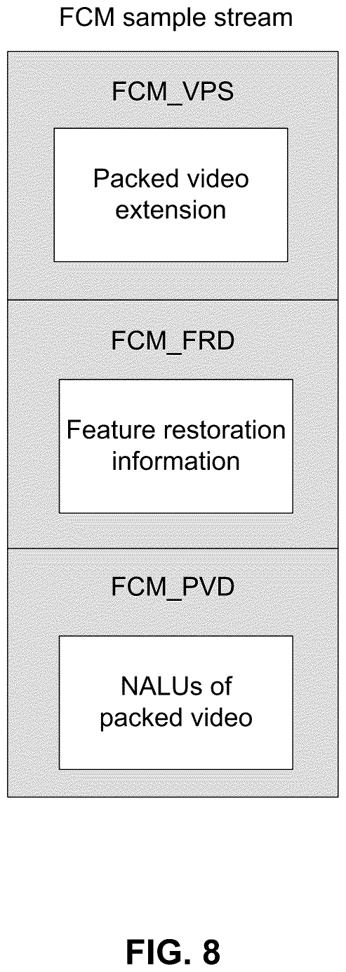

FIG. 8 illustrates an example bitstream organization for FCM. As shown, the bitstream may include sets of NAL units to convey features packed in video frames and/or feature restoration information.

A FCM bitstream structure may include different types of units (e.g., as shown in FIG. 8). The bitstream may include the video parameter set (e.g., FCM_VPS). The video parameter set may include parameters that orchestrate the bitstream. The packed video data (e.g., FCM_PVD units) may be encoded with a traditional codec. The bitstream may include information for conversion and restoration of the reduced and packed tensor channels (e.g., FCM_FRD).

The decoded 2D videos may be synced with the associated parameters transmitted within FCM_FRD units.

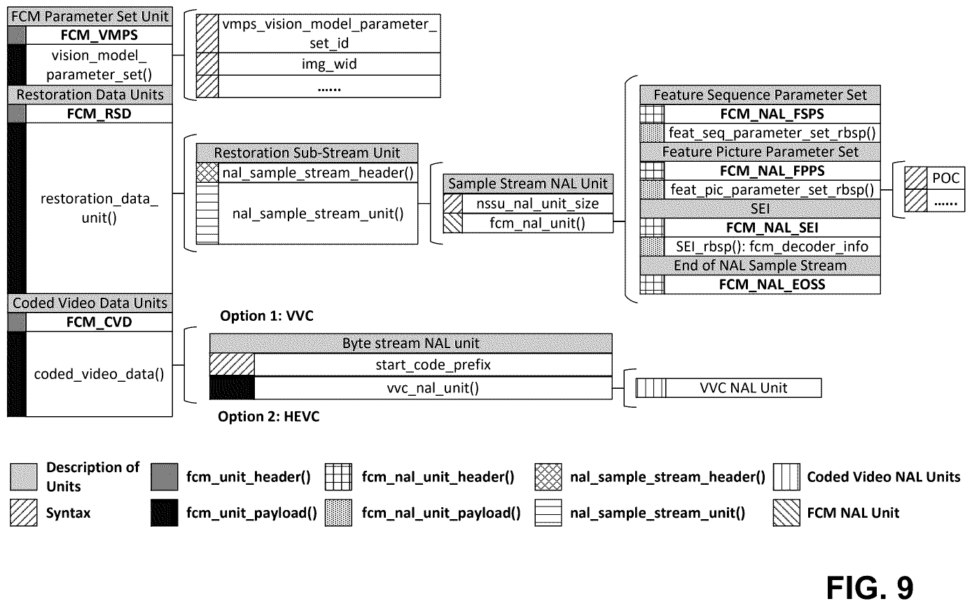

The bitstream may be divided into multiple (e.g., three) unit types. FCM_VMPS units may include information relative to the split vision model. FCM_RSD may include information to convert and restore features from decoded 2D images to feature tensors in their original shapes (e.g., correspond to the FCM_FRD described herein). FCM_CVD may include video sub-bitstream units (e.g. VVC type NALUs). An example organization of the bitstream is shown in FIG. 9. The restoration FSPS and FPPS may be included in restoration sub-stream units. The restoration sub-stream units may improve the bitstream structure. FIG. 9 illustrates an example bitstream structure.

The FPPS (e.g., conveyed within FCM_NAL_FPPS units) may include feature restoration parameters and the POC (e.g., that is missing in some FPPS).

An FCM_NAL_FPPS may be transmitted for a (e.g., each) decoded frame. In video codecs, a picture parameter set (PPS) may not be transmitted for a (e.g., each) decoded frame. The PPS may include information that is shared among other (e.g., subsequent) frames (e.g., conformance window size, maximum size of coding tree units, etc.). Some parameters included in the FPPS may not be transmitted at each frame. With the FPPS mechanism, if a tool is activated (e.g., via the FSPS), related FPPS parameters may be present (e.g., all the time). The decoder may not refer to a previous FPPS. The FPPS may be large if multiple (e.g., many) tools are activated (e.g., with syntax elements coded on many bits). Transmitting fewer PPSs may conserve resources.

The FCM bitstream structure may enable that flexibility (e.g., not transmitting FPPS at each frame). The restoration information may be synchronized with the picture order count of decoded 2D video frame.

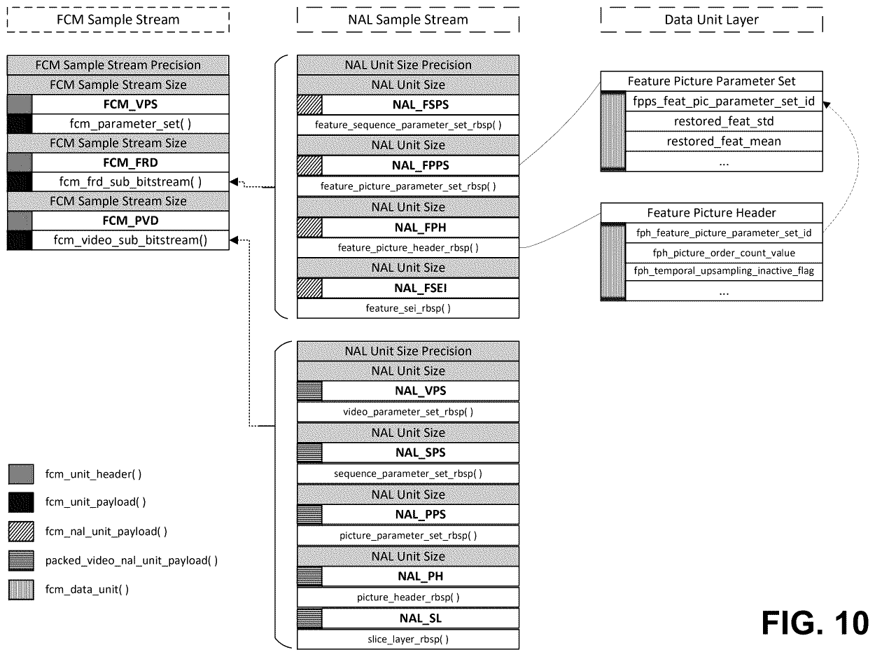

An example bitstream structure may include a feature picture header. FIG. 10 illustrates may example bitstream structure (e.g., FCM bitstream structure).

The bitstream may include (e.g., be decomposed into) three unit types (e.g., denoted sample streams FCM_VPS, FCM_FRD, and FCM_PVD).

The units of type FCM_FRD may include the sub-bitstream with the decoder with feature conversion and restoration parameters. FCM_FRD may include feature sequence parameter sets and/or feature picture parameter sets.

An NAL unit, referred to as NAL_FPH (e.g., in which FPH stands for feature picture header), may be similar to a picture header. The NAL_FPH may include an identifier that points to a corresponding FPPS. The FPH may be coded for a (e.g., every) picture that is coded with the 2D video codec. The FPPS may be shared among different pictures whose FPH points at the same FPPS identifier (e.g., coded with the syntax element fph_feature_picture_parameter_set_id).

The FPH may include the reference to the POC of the corresponding picture decoded by the video codec (e.g., denoted fph_picture_order_count_value). This may help synchronize the conversion and restoration with corresponding decoded 2D frame and restoration parameters. A syntax element (e.g., fph_picture_order_count_value) may be coded as a signed integer on 32 bits.

The FPH may include a flag denoted fph_temporal_upsampling_inactive_flag. If temporal upsampling is active, a decoding process may (e.g., automatically) generate at least one frame (e.g., temporally prior to the current decoded picture). fph_temporal_upsampling_inactive_flag may prevent such a process if no interpolated pictures are produced.

TABLE 3
Example Feature Picture Header (FPH)

| | Descriptor |
|---|---|
| feature_picture_header_rbsp ( ) { | |
| fph_feature_pic_parameter_set_id | ue(v) |
| fph_picture_order_count_value | i(32) |
| if(fsps_temporal_upsampling_enable_flag) { | |
| fph_temporal_upsampling_inactive_flag | u(1) |
| } | |
| rbsp_trailing_bits( ) | |
| } | |

Example information related to a vision model are provided herein.

Information related to the split vision model may be signaled (e.g., as shown in FIG. 9) using a vision model parameter set (e.g., shown in Table 4). The parameters may correspond to the resizing and cropping of the original video to be fed to the NN Part 1 (e.g., which may accept fixed resolution only, or a specific range of resolutions).

TABLE 4
Example Vision Model Parameter Set (VMPS)

Descriptor

```
vision_model_parameter_set_rbsp ( ) {
  vmps_vision_model_parameter_set_id
  img_wid
  img_hei
  scaled_img_wid
  scaled_img_hei
}
```

This information may not be used in the decoding and reconstruction process of features. This information may be used as an indication for the machine task. This information may belong to a dedicated FCM SEI message of type VCM_VM_SEI (e.g., Vision Model).

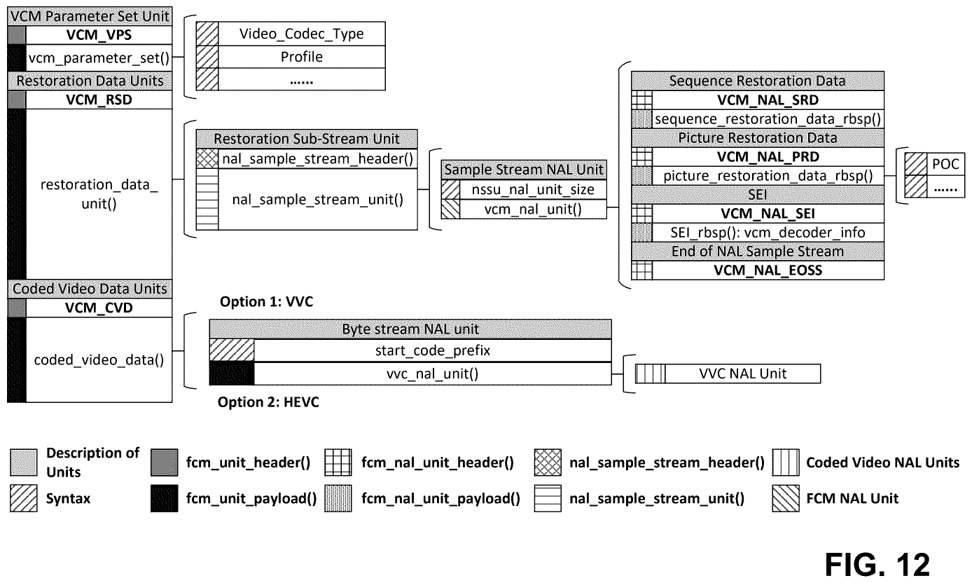

FIG. 12 illustrates an example structure with an SEI coding for vision model (VM) related information.

Split computing may be used. The computer vision task may be performed (e.g., entirely) at the remote device (e.g., requiring the transmission of video content). In this case, a 2D video codec may be used to compress the videos at the sender device. At the receiver, the vision task model may be inferred (e.g., taking decoded video as input).

A video codec may be optimized if the decoded video is analyzed by a vision task. Some codecs may be designed to reduce the bitrate. The degradation introduced by the reduced bitrate may have a low (e.g., minimum) impact on the perceived video by human viewers. A structure may reuse 2D video codecs (e.g., without modifying their implementation). Compression tools may be added to the 2D video codecs. For example, temporal down-sampling may be applied (e.g., if the vision task is run on temporally re-up-sampled decoded videos). The overall structure may be similar to FCM (e.g., with different input(s) and/or output(s) of the codec).

FIG. 12 illustrates an example structure for video coding for machine (VCM) (e.g., which may be similar to the structure for FCM).

The bitstream structure described herein may apply (e.g., directly apply) to VCM. A VCM picture header within the restoration data units may be introduced. The VCM picture header may be transmitted for a (e.g., each) frame (e.g., encoded frame). The VCM picture header may point to the relevant picture parameter set. This may enable the decoder to let the multiple pictures share the same PPS associated with PPS ID (e.g., which refreshes some parameters, for example, only if needed). Similar to the FCM picture header, the VCM picture header (e.g., small size VCM picture header) may include a PPS ID and POC for synchronization with corresponding picture decoded from coded_video_data payloads.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various methods and aspects described herein can be used to modify one or more modules. For example, the intra predictors and inter predictors described with respect to FIGS. 2 and 3 may be implemented as one or more modules and modified according to the various embodiments of the present disclosure.

The various embodiments described herein provide at least the following features, devices or aspects, alone or on any combination, across various claim categories and types:
i. Encoding, into coded video data, syntax elements that can enable the decoder to decode the coded video data, according to any of the embodiments described herein.
ii. Video data (e.g., a bitstream) that may include one or more of the described syntax elements, or variations thereof, whether transmitted, stored, or otherwise made available.
iii. Creating, transmitting, receiving, and/or decoding of the bitstream.
iv. An electronic device (e.g., TV, set-top box, mobile phone, tablet, etc.) that tunes a channel to receive a bitstream or that receives such bitstream over the air. The electronic device decodes the syntax elements from the bitstream, and, optionally, displays (e.g., via a monitor or other type of display) a resulting image.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

“Decoding,” as used herein, encompasses all or part of the processes performed, for example, on an encoded sequence to produce an output suitable for display. In some embodiments, such processes include one or more of the processes typically performed by a decoder, for example, entropy decoding, inverse quantization, etc. Whether the phrase “decoding process” is intended to refer to a subset of operations or generally to the broader decoding process will be clear based on the context of the specific description and will be well understood by those skilled in the art.

“Encoding,” as used herein, encompasses all or part of the processes performed, for example, on input video data an order to produce an encoded bitstream. Additionally, the terms “reconstructed” and “decoded” may be used interchangeably, the terms “encoded” or “coded” may be used interchangeably, the terms “image,” “picture,” “sub-picture,” “slice,” and “frame” may be used interchangeably, and the terms “pixel” and “sample” may be used interchangeably.

The present disclosure refers to information, for example, syntax elements, that can be transmitted or stored. Such information can be packaged or arranged in a variety of manners, including for example manners common in video standards such as putting the information into a sequence parameter set (SPS), a picture parameter set (PPS), a network abstraction layer (NAL) unit, a header (for example, a NAL unit header, or a slice header), or an SEI message. Other manners are also available, including, for example, manners that are common for system level or application-level standards such as signaling the information into one or more of the following:
i. session description protocol (SDP), for example as described in RFCs and/or used in conjunction with real-time transport protocol (RTP) transmission.
ii. HTTP live Streaming (HLS) manifest transmitted over HTTP.
iii. DASH MPD descriptors, for example as used in DASH and transmitted over HTTP.
iv. RTP header extensions, for example as used during RTP streaming.
v. International Organization for Standardization (ISO) base media file format, for example, as used in Omnidirectional MediA Format (OMAF).

As used herein, “signal” and “signaling” refer to, among other things, indicating information to a decoder. For example, in some embodiments the encoder signals a quantization matrix for de-quantization, whereby the same parameter may be used for both encoding and decoding. In some embodiments, the signaling may be explicit, such that information (e.g., a particular parameter) is transmitted to the decoder enabling the decoder to use the same particular parameter. In some embodiments, the signaling may be implicit, in that the information (e.g., a particular parameter) is indicated based on other information at or transmitted to the decoder or derived or selected by the decoder based on information available at the decoder. By not transmitting the information (e.g., the particular parameter), bit savings is thus realized in some embodiments. In some embodiments, one or more syntax elements or flags are used to signal information to a decoder. While the preceding relates to the verb form of the word “signal”, the word “signal” can also be used herein as a noun.

In some embodiments, signals may be produced that are formatted to carry information that may be stored or transmitted. Such information may include, for example, instructions for performing a method, or data produced by one of the described implementations (e.g., a bitstream of a described embodiment). Such a signal may be formatted, for example, as an electromagnetic wave or as a baseband signal. The formatting may include, for example, encoding a data stream and modulating a carrier with the encoded data stream. The information that the signal carries may be, for example, analog or digital information. The signal may be transmitted over a variety of different wired or wireless links and may be stored on a processor-readable medium.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

What is claimed is:

1. A device for video decoding, the device comprising:
a processor configured to:
receive a feature picture header (FPH) network abstraction layer (NAL) unit, wherein the FPH NAL unit comprises an identifier of a frame;
associate the frame with the FPH NAL unit based on the identifier of the frame; and
reconstruct a set of features associated with the frame based on the FPH NAL unit.

2. The device of claim 1, wherein the identifier of the frame comprises an indication of a picture order count associated with the frame.

3. The device of claim 1, wherein the frame is a first frame, the FPH NAL unit further indicates whether temporal up-sampling is enabled, and the processor is further configured to, on a condition that temporal up-sampling is enabled, automatically generate a second frame that is temporarily prior to the first frame.

4. The device of claim 1, wherein the FPH NAL unit further indicates whether temporal up-sampling is enabled, and the processor is further configured to, on a condition that temporal up-sampling is disabled, determine to skip temporal up-sampling.

5. The device of claim 1, wherein the processor is further configured to use the reconstructed set of features as an input to at least a part of a neural network.

6. The device of claim 1, wherein the FPH NAL unit is a first FPH NAL unit, the identifier of the frame is a first identifier of a first frame, the set of features is a first set of features, and the processor is further configured to:
receive a second FPH NAL unit, wherein the second FPH NAL unit comprises a second identifier of a second frame;
associate the second frame with the second FPH NAL unit based on the second identifier of the second frame; and
reconstruct a second set of features associated with the second frame based on the second FPH NAL unit.

7. The device of claim 1, wherein the FPH NAL unit further indicates a feature picture parameter set (FPPS) and the processor being configured to reconstruct the set of features associated with the frame based on the FPH NAL unit comprises the processor being configured to reconstruct the set of features associated with the frame based on the FPPS.

8. The device of claim 1, wherein the FPH NAL unit further indicates a feature picture parameter set (FPPS), the FPPS comprises a parameter for reconstructing intermediate data associated with the frame, and the processor being configured to reconstruct the set of features associated with the frame based on the FPH NAL unit comprises the processor being configured to reconstruct the set of features based on the parameter for reconstructing the intermediate data associated with the frame.

9. The device of claim 1, wherein the frame is a decoded video frame.

10. A device for video encoding, the device comprising:
a processor configured to:
associate a feature picture header (FPH) network abstraction layer (NAL) unit with a frame;
encode the FPH NAL unit, wherein the FPH NAL unit comprises an identifier of the frame; and
include the encoded FPH NAL unit in video data.

11. The device of claim 10, wherein the identifier of the frame comprises an indication of a picture order count associated with the frame.

12. The device of claim 10, wherein the frame is a first frame, the processor is further configured to determine that temporal up-sampling is enabled, and the FPH NAL unit further comprises an indication to use temporal up-sampling to automatically generate a second frame that is temporarily prior to the first frame.

13. The device of claim 10, wherein the processor is further configured to determine that temporal up-sampling is disabled, and the FPH NAL unit further comprises an indication to skip temporal up-sampling.

14. The device of claim 10, wherein the processor is further configured to receive, from an output of at least a part of a neural network, intermediate data associated with feature reconstruction, and wherein the FPH NAL unit indicates the intermediate data.

15. The device of claim 10, wherein the FPH NAL unit is a first FPH NAL unit, the identifier of the frame is a first identifier of a first frame, and the processor is further configured to:
associate a second FPH NAL unit with a second frame;
encode the second FPH NAL unit, wherein the second FPH NAL unit comprises a second identifier of the second frame; and
include the encoded second FPH NAL unit in the video data.

16. The device of claim 10, wherein the processor is further configured to determine a feature picture parameter set (FPPS) associated with the frame, wherein the FPH NAL unit further indicates the FPPS.

17. The device of claim 10, wherein the processor is further configured to receive, from at least a part of a neural network, features associated with the frame, and the processor is further configured to determine a feature picture parameter set (FPPS) based on the features associated with the frame, wherein the FPH NAL unit further indicates the FPPS.

18. The device of claim 10, wherein the frame is an encoded video frame.

19. A method for video decoding, the method comprising:
receiving a feature picture header (FPH) network abstraction layer (NAL) unit, wherein the FPH NAL unit comprises an identifier of a frame;
associating the frame with the FPH NAL unit based on the identifier of the frame; and
reconstructing a set of features associated with the frame based on the FPH NAL unit.

20. The method of claim 19, wherein the identifier of the frame comprises an indication of a picture order count associated with the frame.
